(19) United States
(12) Patent Application Publication
(10) Pub. No.: US 2012/0102271 A1
(43) Pub. Date: Apr. 26, 2012

(54) CACHE MEMORY SYSTEM AND CACHE MEMORY CONTROL METHOD

(76) Inventor: Yasushi Kanoh, Tokyo (JP)

(21) Appl. No.: 13/148,896

(22) PCT Filed: Jan. 15, 2010
(86) PCT No.: PCT/JP10/50369

§ 371 Date: Aug. 10, 2011

(30) Foreign Application Priority Data
Feb. 27, 2009 (JP) 2009-045989

(51) Int. Cl. G06F 12/12

(52) U.S. Cl. 711/133; 711/E12.07

(57) ABSTRACT

The number of ways of address arrays (102, 103, and 104) is made greater than the number of ways of data arrays (105 and 106). At the time of a mishit, a request is issued to read from memory (3) block data of the address of the mishit and the address in an address entry of an available address array. At this time, the address entry of an address array and the data entry of a data array that correspond to block data to be replaced are kept valid until the arrival of the block data corresponding to the read request in cache memory system (1) from memory (3). Therefore, access from CPU (2) to block data to be replaced can be handled as a cache hit when access occurs before the block data corresponding to the read request arrive in the cache memory system (1) from memory 3.

### TECHNICAL FIELD

The present invention relates to a cache memory system and cache memory control method that can be used in a computer system.

### BACKGROUND ART

Cache memory is provided between an arithmetic unit such as a CPU and a main memory. Cache memory stores a portion of data that are in the main memory. Cache memory exchanges data with the arithmetic unit.

Cache memory is used to improve the accessibility of memory of a computer by using temporal locality of access according to which data that have been accessed one time have a higher likelihood of being accessed again and spatial locality of access according to which data that are close to data that have been accessed one time have a higher likelihood of being accessed.

However, the capacity of built-in cache memory is typically limited, and a method is therefore needed for efficiently using a cache memory of limited capacity to improve the cache hit ratio.

The data storage areas among a plurality of storage areas (hereinbelow referred to as “data entries”) in the cache memory into which are stored block data made up from a plurality of items of data that have been read from the main memory differ according to the cache memory mapping scheme. The addresses in the data main memory of the plurality of items of data in block data are contiguous.

A scheme that allows the most efficient use of a cache memory is a scheme referred to as “full-associative.” In the full-associative scheme, block data that are read from the memory can be stored in any of the plurality of data entries in a cache memory.

However, when searching to determine whether data that have been requested from a CPU are in the cache memory in the full-associative scheme, all data entries in the cache memory must be made the object of the search, and this requirement complicates the achievement of a high-speed search in a short time.

The direct-mapping scheme achieves the greatest simplification of searching to determine whether data that have been requested from a CPU are in a cache memory.

In the direct-mapping scheme, block data that have been read from the main memory are stored in one data entry that is specified by the intermediate-order bits of the address among the plurality of data entries in the cache memory.

In the direct-mapping scheme, however, only one data entry is set for a plurality of block data (hereinbelow referred to as “address-correspondence block data”) for which intermediate-order bits of the address are identical but for which the higher-order bits of the address are different. As a result, this plurality of address-correspondence block data cannot be cached (stored) in a cache memory at the same time.

A scheme that is between these two schemes is known as the N- (where N is an integer equal to or greater than 2) way set-associative scheme.

In the N-way set-associative scheme, N data entries exist for storing a plurality of address-correspondence block data. As a result, N items of address-correspondence block data can be cached simultaneously. In addition, a plurality of address storage areas (hereinbelow referred to as “address entries”) are provided that correspond one-to-one with each data entry, and the address of block data in the corresponding data entry is stored in each address entry.

When searching to determine whether data that have been requested from the CPU are in the cache memory in the N-way set-associative scheme, the N address entries that correspond to the intermediate-order bits of the address of the data that have been requested are searched.

Patent Document 1 (JP-A-H04-270431) discloses an apparatus referred to as a victim cache memory that stores block data that have been replaced in order to cache other block data at the time of a cache miss, i.e., block data that have been evicted from the cache memory (see paragraph 0023).

The victim cache memory described in Patent Document 1 is a full-associative cache memory of small capacity (several blocks) and caches block data that have been replaced by the cache memory.

When block data in the victim cache memory are the object of a cache hit, the block data that were hit are returned to the cache memory.

A victim cache memory has a capacity of only several items of block data. As a result, the time during which block data are held in the victim cache memory is considered to be short.

The technology described in Patent Document 1 improves the hit ratio of cache memory by taking advantage of the fact that block data that have been once cached in the cache memory and then replaced, i.e., block data that have been evicted from the cache memory, have a high possibility of being accessed again, and moreover, of being accessed immediately after being replaced.

On the other hand, cache memory is coming into use for memory access by a plurality of threads that are executed substantially simultaneously due to the development of multicore technology and multithread technology in CPUs.

These memory accesses are realized by a plurality of independent threads and result in the occurrence of a plurality of substantially simultaneous cache misses without any causal relationship to memory access.

Accordingly, compared to a single core or a single thread, substantially simultaneous cache misses occur with greater frequency and a plurality of memory accesses also occur simultaneously due to cache misses.

### LITERATURE OF THE PRIOR ART

### Patent Documents

Patent Document 1: JP-A-H04-270431

### SUMMARY OF THE INVENTION

### Problem to be Solved by the Invention

A technology that employs a victim cache memory is unable to efficiently process memory accesses from a CPU realized by multicore or multithread in which a plurality of cache misses occur at substantially the same time.

This inability arises because a victim cache memory is a full-associative cache memory of small capacity (several blocks), and when a plurality of cache misses occur at substantially the same time, the amount of block data for which cache misses occur exceeds the capacity of the victim cache memory. Increasing the capacity of the victim cache memory in order to cope with a plurality of cache misses only complicates the realization of the full-associative scheme. In addition, a process for moving the block data, for which cache misses occur, to a victim cache memory also becomes necessary.

It is an object of the present invention to provide a cache memory system and cache memory control method that can solve the above-described problems.

### Means for Solving the Problem

The cache memory system of the present invention is a cache memory system that is connected to an arithmetic unit and a memory apparatus and includes:

an address storage unit that stores, from among a multiplicity of address groups in which addresses of the memory apparatus are organized by a predetermined number, a plurality of address groups that are fewer in number than the multiplicity of address groups;

a data storage unit that stores a plurality of block data that correspond to each of the plurality of address groups; and

a control unit that, when a reception address from the arithmetic unit is not in the address storage unit, specifies a replacement-object address group from among the plurality of address groups, and moreover, stores in the address storage unit, from among the multiplicity of address groups, a relevant address group that includes the reception address and then reads from the memory apparatus relevant block data that correspond to the relevant address group and stores the relevant block data in the data storage unit;

wherein the control unit determines, which a cache hit has occurred in the event of receiving from the arithmetic unit an address in the replacement-object address group, in a reading interval from specifying the replacement-object address group until reading the relevant block data from the memory apparatus, and in the event of not receiving from the arithmetic unit an address in the replacement-object address group in the reading interval, both stores the relevant block data in the data storage unit in place of corresponding block data that correspond to the replacement-object address group and invalidates the replacement-object address group.

The cache memory control method of the present invention is a cache memory control method that is carried out by a cache memory system that is connected to an arithmetic unit and an memory apparatus and includes steps of executing operations of:

storing in an address storage unit, from among a multiplicity of address groups in which addresses of the memory apparatus are organized by a predetermined number, a plurality of address groups that is fewer in number than the multiplicity of address groups;

storing in a data storage unit a plurality of block data that correspond to each of the plurality of address groups; and

when a reception address from the arithmetic unit is not in the address storage unit, specifying a replacement-object address group from among the plurality of address groups, and moreover, storing in the address storage unit, from among the multiplicity of address groups, a relevant address group that includes the reception address, then reading from the memory apparatus relevant block data that correspond to the relevant address group, and storing the relevant block data in the data storage unit;

wherein the execution of these operations includes: determining, which a cache hit has occurred in the event of receiving from the arithmetic unit,an address in the replacement-object address group, in a reading interval from specifying the replacement-object address group until reading the relevant block data from the memory apparatus, and in the event of not receiving from the arithmetic unit an address in the replacement-object address group in the reading interval, both storing the relevant block data in the data storage unit in place of corresponding block data that correspond to the replacement-object address group and invalidating the replacement-object address group.

### Effect of the Invention

According to the present invention, in the interval until block data that include data for which a cache miss has occurred are read from a memory and stored in data storage means, block data and an address group that have become the object of replacement due to the cache miss can be the object of a cache hit, whereby the cache hit ratio can be improved.

### BRIEF DESCRIPTION OF THE DRAWINGS

FIG. 1 shows the configuration of the cache memory system of the first exemplary embodiment of the present invention;

FIG. 2 shows a bit string that represents the status of cache memory;

FIG. 3 shows a bit string of a control array of cache memory;

FIG. 4 is a flow chart for describing the operations of cache memory;

FIG. 5 is a flow chart for describing the operations of replacing a block and reading a block of cache memory;

FIG. 6 is a flow chart for describing the operations of changing the object of replacement of cache memory and updating the LRU;

FIG. 7A is an explanatory view for describing the operations of cache memory;

FIG. 7B is an explanatory view for describing the operations of cache memory;

FIG. 7C is an explanatory view for describing the operations of cache memory;

FIG. 7D is an explanatory view for describing the operations of cache memory;

FIG. 7E is an explanatory view for describing the operations of cache memory; and

FIG. 7F is an explanatory view for describing the operations of cache memory.

### MODE FOR CARRYING OUT THE INVENTION

An exemplary embodiment of the present invention is next described with reference to the accompanying drawings.

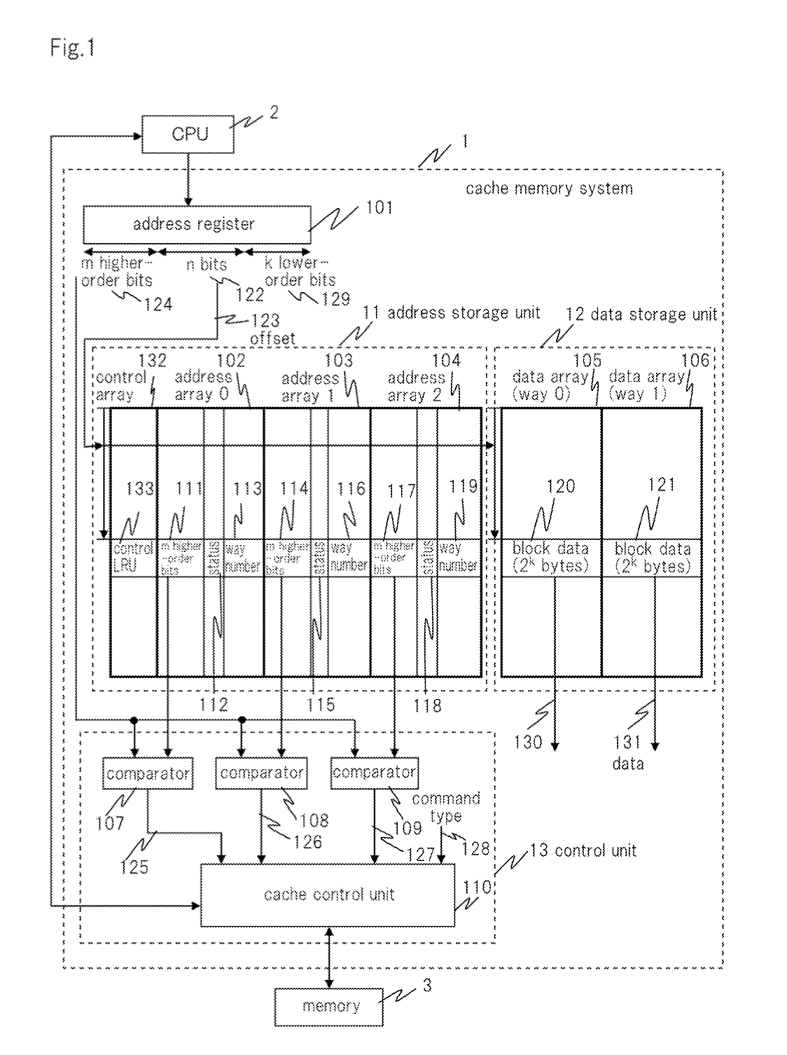

FIG. 1 is a block diagram showing the cache memory system of an exemplary embodiment of the present invention.

In FIG. 1, cache memory system 1 is connected to CPU 2 and memory 3. CPU 2 can be called a typical arithmetic unit. CPU 2 may be a single-core processor, a multicore processor, or a multithread processor. Memory 3 can be called a typical memory apparatus.

Cache memory system 1 includes address register 101, address arrays 102-104, data arrays 105-106, control array 132, comparators 107-109, and cache control unit 110.

Address array number “0” is conferred to address array 102. Address array number “1” is conferred to address array 103. Address array number “2” is conferred to address array 104.

Way number “way−0” is conferred to data array 105. Way number “way−1” is conferred to data array 106.

Address arrays 102-104 and control array 132 are included in address storage unit 11. Data arrays 105-106 are included in data storage unit 12. Comparators 107-109 and cache control unit 110 are included in control unit 13.

Address register 101 stores an address (hereinbelow referred to as “reception address”) requested by CPU 2. Addresses stored in address register 101 are represented by data (values) of m higher-order bits 124, data (values) of n intermediate-order bits 122, and data (values) of k lower-order bits 129.

The data of m higher-order bits 124 are provided to each of comparators 107-109, and the data of n intermediate-order bits 122 are provided as offset 123 to address arrays 102-104, data arrays 105-106, and control array 132.

Address storage unit 11 can be referred to as typical address storage means. Address storage unit 11 stores, from among the multiplicity of address groups into which the addresses belonging to memory 3 have been organized by a predetermined number, a plurality of address groups that is fewer in number than the multiplicity of address groups.

Data storage unit 12 can be referred to as typical data storage means. Data storage unit 12 stores a plurality of block data that correspond to each of the plurality of address groups in address storage unit 11. Each item of block data is composed of a plurality of items of data.

Control unit 13 can be referred to as typical control means.

When an address (hereinbelow referred to as “reception address”) received by cache memory system 1 from CPU 2 is not in address storage unit 11, i.e., when a cache miss occurs, control unit 13 specifies a replacement-object address group from among the plurality of address groups in address storage unit 11.

Alternatively, when a cache miss occurs, control unit 13 stores the address group (hereinbelow referred to as the “relevant address group”) that includes the reception address in address storage unit 11, from among a multiplicity of address groups (more specifically, the multiplicity of address groups into which addresses belonging to memory 3 have been organized by a predetermined number).

Control unit 13 next reads from memory 3 block data (hereinbelow referred to as “relevant block data”) that correspond to the relevant address group.

During the interval (hereinbelow referred to as the “reading interval”) from specifying the replacement-object address group until reading the relevant block data from memory 3, the replacement-object address group is present in address storage unit 11, and moreover, the block data (hereinbelow referred to as the “corresponding block data”) that correspond to the replacement-object address group are present in data storage unit 12.

Thus, when cache memory system 1 receives an address in the replacement-object address group from CPU 2 during the reading interval, control unit 13 judges that a cache hit has occurred.

If cache memory system 1 does not received an address in the replacement-object address group from CPU 2 during the reading interval, control unit 13 stores the relevant block data that were read from memory 3 in data storage unit 12 in place of the corresponding block data.

In addition to storing the relevant block data, control unit 13 invalidates the replacement-object address group in address storage unit 11.

In addition, if cache memory system 1 receives an address in the replacement-object address group from the CPU during the reading interval, control unit 13 further changes the replacement-object address group to another address group (however, a group that differs from the relevant address group) from among the plurality of address groups in address storage unit 11.

Control unit 13 next both stores the relevant block data that were read from memory 3 in data storage unit 12 in place of the block data that correspond to the replacement-object address group after the change and invalidates the replacement-object address group that follows the change in address storage unit 11.

In the present exemplary embodiment, each of the multiplicity of address groups, in which the plurality of addresses belonging to memory 3 have been organized by a predetermined number, is composed of a plurality of addresses in which, when each address of memory 3 is divided into higher-order bits 124, intermediate-order bits 122, and lower-order bits 129, the values of higher-order bits 124 and the values of intermediate-order bits 122 are shared.

For each index (also referred to as “offset”) that indicates each of a plurality of values that can be represented by intermediate-order bits 122, data storage unit 12 has N (where N is an integer equal to or greater than 2) data storage areas (hereinbelow referred to as “data entries”) that correspond to the index. In the present exemplary embodiment, N is assumed to equal “2.”

In the present exemplary embodiment, each of data arrays 105 and 106 in data storage unit 12 has for each index (offset) one data entry that corresponds to the index.

Each of the plurality of items of block data in data storage unit 12 is separately stored in a data entry that corresponds to the index that indicates the value of intermediate-order bits 122 of the address group that corresponds to the block data.

Address storage unit 11 has, for each index (offset) described hereinabove, M (where M is an integer greater than N) address storage areas (hereinbelow referred to as “address entries”) that correspond to the index. In the present exemplary embodiment, M is assumed to equal “3.”

In the present exemplary embodiment, each of address arrays 102-104 in address storage unit 11 has, for each index (offset), one address entry that corresponds to the index.

In addition, address storage unit 11 has, for each index (offset) described above, a control information storage area (hereinbelow referred to as “control information entry”) that corresponds to the index.

In the present exemplary embodiment, control array 132 in address storage unit 11 has, for each index (offset), one control information entry that corresponds to the index.

Each of the plurality of address groups in address storage unit 11 is separately stored in an address entry that corresponds to the index that indicates the value of the intermediate-order bits 122 of that address group.

When a cache miss occurs, control unit 13 specifies, among the plurality of address groups in address storage unit 11, a replacement-object address group from among address groups that include the same intermediate-order bits 122 as the reception address.

When a cache miss occurs, control unit 13 further stores a relevant address group in an address entry that is unused or that has been invalidated among the plurality of address entries that correspond to the index (offset) that indicates the value of intermediate-order bits 122 of the reception address.

If cache memory system 1 does not receive an address in the replacement-object address group from CPU 2 during a reading interval, control unit 13 both stores the relevant block data in the data entry that stores the corresponding block data in place of the corresponding block data and invalidates the replacement-object address group.

If, on the other hand, cache memory system 1 receives an address in the replacement-object address group from CPU 2 during a reading interval, control unit 13 changes the replacement-object address group to, from among the plurality of address groups in address storage unit 11, another address group in the address groups that contains intermediate-order bits 122 that are the same as the reception address.

Control unit 13 next both stores the relevant block data that were read from memory 3 in the data entry that stores block data (hereinbelow referred to as “related block data”) that correspond to the replacement-object address group that follows the change in place of the related block data and invalidates the replacement-object address group that follows the change in address storage unit 11.

The address entry also stores storage destination information that indicates the data entry in which block data are stored that correspond to the address group that it stores. Control unit 13 refers to the storage destination information in the address entry to identify the data entry in which the corresponding block data are stored.

Each of address arrays 102-104 is a memory having a number of address entries that is 2 to the nth power. Each of data arrays 105-106 is also a memory that has a number of data entries that is 2 to the nth power. Data entries that store block data have a one-to-one correspondence with the plurality of address entries. Each of data arrays 105-106 has a plurality of data entries composed of a plurality of words.

Address arrays 102-104 are used as indices of block data that are stored in block units in the data entries of data arrays 105-106.

Each address entry of address array 102 includes for each offset (index) that corresponds to n intermediate-order bits 122, in higher-order bits 111 of the address, bit string (hereinbelow also referred to as “status information”) 112 that represents the status of block data in the corresponding data entry, and way-number information 113 that indicates the way number of the data array that has the corresponding data entry.

Address array 102 stores an address group using the m higher-order bits 111 of the address and the offset. This address group signifies a plurality of addresses in which the data of m higher-order bits and n intermediate-order bits are prescribed, and moreover, the data of k lower-order bits are any values.

Each address entry of address array 103 includes, for each offset (index) that corresponds to n intermediate-order bits 122, m higher-order bits 114 of the address, bit string (status information) 115 that represents the status of the block data in the corresponding data entry, and way-number information 116 that indicates the way number of the data array that has the corresponding data entry.

Address array 103 uses m higher-order bits 114 of the address and offset to store an address group. This address group signifies a plurality of addresses in which the data of the m higher-order bits and the n intermediate-order bits are prescribed and the data of the k lower-order bits are any values.

Each address entry of address array 104 includes, for each offset (index) that corresponds to n intermediate-order bits 122, in higher-order bits 117 of the address, bit string (status information) 118 that represents the status of block data in the corresponding data entry, and way-number information 119 that indicates the way number of the data array that has the corresponding data entry.

Address array 104 uses m higher-order bits 117 of the address and the offset to store an address group. This address group signifies a plurality of addresses in which the data of the m higher-order bits and n intermediate-order bits are prescribed and the data of the k lower-order bits are any values.

Way-number information 113, 116, and 119 can be called typical storage destination information.

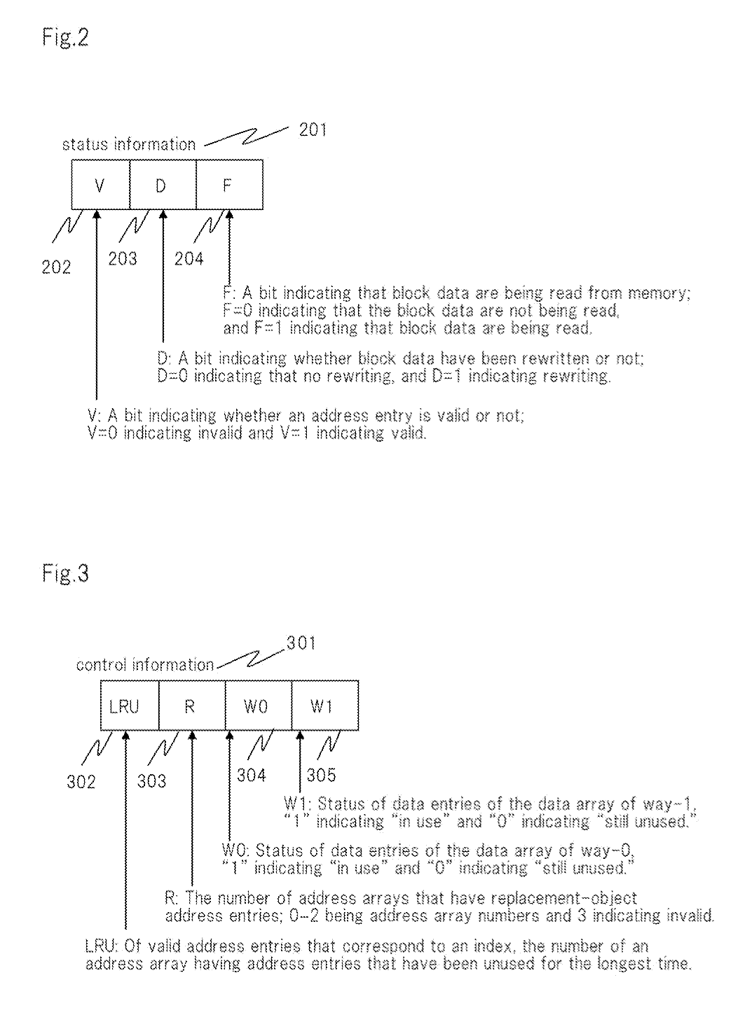

FIG. 2 is an explanatory view for describing status information 112, 115, and 118. In FIG. 2, status information 112, 115, and 118 are shown as status information 201.

Status information 201 is made up from three bits. More specifically, status information 201 is composed of V202 of one bit, D203 of one bit, and F204 of one bit.

V202 indicates whether the address entry that includes V202 is valid. In the present exemplary embodiment, V=0 indicates that the address entry that includes V202 is invalidated, and further, that the address group in the address entry that includes V202 is invalidated; and V=1 indicates that the address entry that includes V202 is valid, and further, that the address group in the address entry that includes V202 is valid.

D203 indicates whether, of the block data in the data entry, the block data that correspond to the address group in the address entry that includes D203 have been rewritten or not. In the present exemplary embodiment, D203=0 indicates that the block data have not been rewritten, and D203=1 indicates that the block data have been rewritten.

F204 indicates whether the block data that correspond to the address group in the address entry that includes F204 are being read from memory 3 or not. In the present exemplary embodiment, F204=0 indicates that the block data are not being read, and F204=1 indicates that the block data are being read.

Returning to FIG. 1, each data entry in data arrays 105-106 stores block data 120 or 121 of 2^{k} bytes.

Control array 132 is memory that has 2ⁿ control information entries. Each control information entry stores control information 133 that indicates LRU (Least Recently Used) and other information.

FIG. 3 is an explanatory view for describing control information 133. In FIG. 3, control information 133 is shown as control information 301.

Control information 301 is made up from LRU302, R303, W0304, and W1305.

LRU302 stores the number of the address array that has, from among the valid address entries among address entries that correspond to the index to which LRU302 corresponds, the address entry that has the longest time of non-use.

R303 stores the number of the address array that has, among valid address entries among address entries that correspond to the index to which R303 corresponds, the address entry that stores the replacement-object address group.

R303=3 indicates that the address entry that stores the replacement-object address group does not exist (is invalid).

W0304 indicates whether, of the data entries that correspond to the index, to which W0304 corresponds, data entries in data array 105 to which way number “way−0” is conferred, are in use or not.

For example, W0304=1 indicates that data entries are in use, and W0304=0 indicates that data entries are not in use.

W1305 indicates whether, of data entries that correspond to the index, which corresponds to W1305, the data entries in data array 106 to which way number “way−1” is conferred, are in use or not.

For example, W1305=1 indicates that the data entries are in use, and W0304=0 indicates that the data entries are unused.

Returning to FIG. 1, comparator 107 compares data of m higher-order bits 111 from address array 102 with the data of m higher-order bits 124 from address register 101.

When address array 102 is accessed using n intermediate-order bits 122 of address register 101 as offset 123, the data of m higher-order bits 111 that are provided to comparator 107 are data supplied from address array 102.

Comparator 108 compares the data of m higher-order bits 114 from address array 103 and the data of m higher-order bits 124 from address register 101.

When address array 103 is accessed using n intermediate-order bits 122 of address register 101 as offset 123, the data of m higher-order bits 114 that are provided to comparator 108 are data that are supplied from address array 103.

Comparator 109 compares the data of m higher-order bits 117 from address array 104 and the data of m higher-order bits 124 from address register 101.

When address array 104 is accessed using n intermediate-order bits 122 of address register 101 as offset 123, the data of m higher-order bits 117 that are provided to comparator 109 are data supplied from address array 104.

Cache control unit 110 controls the cache memory (specifically, address storage unit 11 and data storage unit 12) based on comparison result 125 from comparator 107, comparison result 126 from comparator 108, comparison result 127 from comparator 109, command type information (for example, either of load (reading) and store (writing)) 128 from CPU 2, status information 112 from address array 102, status information 115 from address array 103, status information 118 from address array 104, way-number information 113 from address array 102, way-number information 116 from address array 103, way-number information 119 from address array 104, and control information 133 from control array 132.

When address array 102 is accessed using n intermediate-order bits 122 of address register 101 as offset 123, status information 112 and way-number information 113 are supplied to cache control unit 110 from address array 102.

When address array 103 is accessed using n intermediate-order bits 122 of address register 101 as offset 123, status information 115 and way-number information 116 are supplied to cache control unit 110 from address array 103.

When address array 104 is accessed using n intermediate-order bits 123 of address register 101 as offset 123, status information 118 and way-number information 119 are supplied to cache control unit 110 from address array 104.

Control information 133 is supplied to cache control unit 110 from control array 132 when n intermediate-order bits 122 of address register 101 are used as offset 123 to access control array 132.

In the following explanation, the addresses that are stored in address register 101 are assumed to be of 64 bits and k=6, i.e., the size of the block data is assumed to be 64 bytes and n=10; i.e., the number of address entries of address arrays 102-104, the number of data entries of data arrays 105-106, and the number of control information entries of control array 132 are assumed to be 1024 and m=48. In addition, block data of 64 bytes are composed of 8 words. One word is eight bytes.

In the present exemplary embodiment, a cache memory of the two-way set-associative scheme is shown, but the number of ways can be freely set.

In addition, in the present exemplary embodiment, the number of address arrays is “number of ways+1,” but the number of address arrays can be set to any number greater than the number of ways. The number of comparators and the number of address arrays are made equal.

The operations of cache memory system 1 shown in FIG. 1 are next described.

When cache memory system 1 is accessed, address register 101 stores the address. This address may be a logical address or a physical address.

In the present exemplary embodiment, explanation is presented on the assumption that this address is translated from a virtual address to a physical address by some means of address translation.

Because the size of block data is 64 bytes, the data of 6 (k) lower-order bits 129 of address register 101 are the addresses of words in block data in in data arrays 105 and 106.

The data of 10 (n) intermediate-order bits 122 are used as offset 123 of address arrays 102-104, and the data in data entries of address arrays 102-104 are read.

Comparator 107 compares the data of 48 (m) higher-order bits 111 in the data that were read from address array 102 and data of 48 (m) higher-order bits 124 in address register 101 and provides comparison result 125 to cache control unit 110.

Comparator 108 compares the data of 48 (m) higher-order bits 114 in the data that were read from address array 103 and the data of 48 (m) higher-order bits 124 in address register 101 and provides comparison result 126 to cache control unit 110.

Comparator 109 compares the data of 48 (m) higher-order bits 117 in the data that were read from address array 104 and the data of 48 (m) higher-order bits 124 in address register 101 and provides comparison result 127 to cache control unit 110.

Cache control unit 110 receives command type information (in the present exemplary embodiment, “load” or “store”) 128, status information 112,115, and 118, way-number information 113,116, and 119, and control information 133 together with comparison results 125-127, and based on this information, determines the operation of cache memory system 1. Command type information 128 is provided from CPU 2.

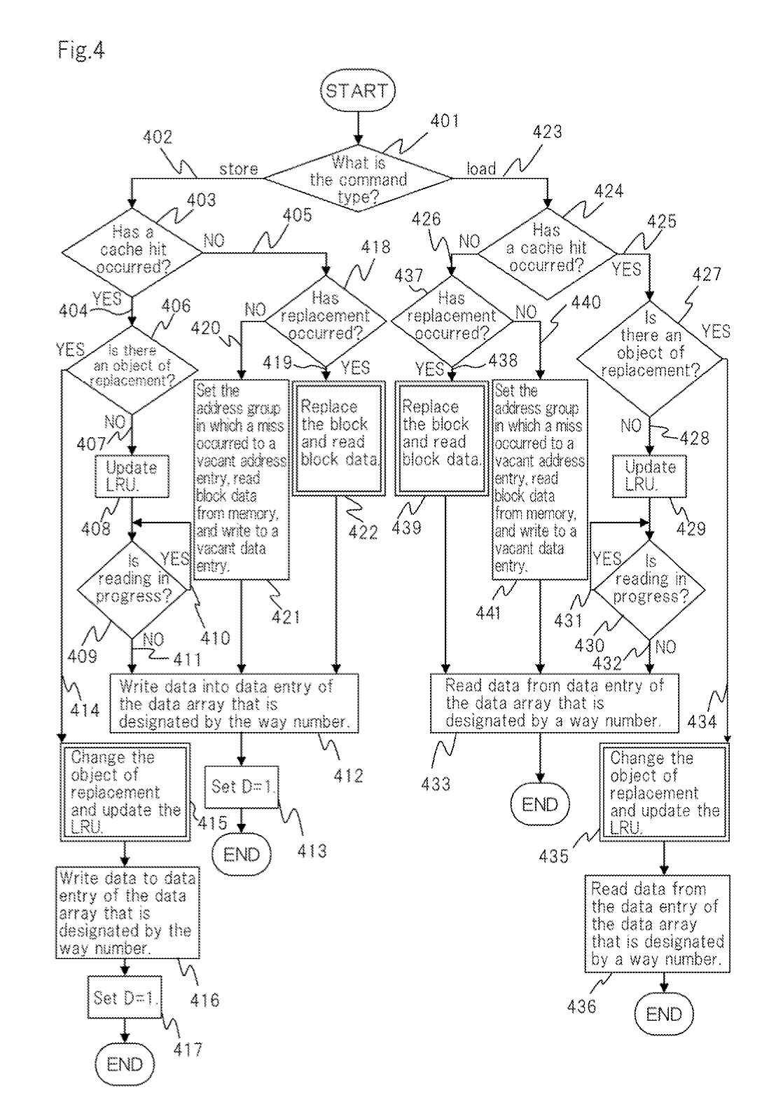

FIG. 4 is a flow chart for describing the operations of cache control unit 110.

When address register 101 stores the address that was accessed in cache memory system 1, the address entries of address arrays 102-104, the data entries of data arrays 105-106, and the control information entries of control array 132 are subsequently accessed using the data of 10 (n) intermediate-order bits 122 of the address as offset 123 of address arrays 102-104, data arrays 105-106, and control array 132,

At this time, cache control unit 110 receives the data of 6 (k) lower-order bits 129 from CPU 2. In addition, cache control unit 110 further receives from CPU 2 data for writing that is indicated by a store command when the access is for writing (store).

Cache control unit 110 judges whether the command type information 128 is a store command or load command (Step 401).

First, when command type information 128 is a store command (Step 402), cache control unit 110 executes Step 403.

In Step 403, cache control unit 110 determines based on comparison results 125-127 and status information 112,115, and 118 whether the accessed data are in data storage unit 12, i.e., determines whether a cache hit has occurred.

Cache control unit 110 determines that a cache hit has occurred when both comparison result 125 indicates matching and V202 in status information 112 indicates “1,” when both comparison result 126 indicates matching and V202 of status information 115 indicates “1,” or when both comparison result 127 indicates matching and V202 of status information 118 indicates “1” (Step 404).

On the other hand, when all of the following conditions 1-3 are satisfied, cache control unit 110 determines that a cache miss has occurred (Step 405).

Condition 1: Comparison result 125 does not indicate matching, or V202 in status information 112 indicates “0.”

Condition 2: Comparison result 126 does not indicate matching, or V202 in status information 115 indicates “0.”

Condition 3: Comparison result 127 does not indicate matching, or V202 in status information 118 indicates “0.”

When a cache hit is determined (Step 404), cache control unit 110 determines whether the address at which the cache hit occurred is an address in the replacement-object address group by checking whether the value indicated by R303 in control information 133 matches the address array number of the cache hit (Step 406).

If the address of the cache hit is not an address in the replacement-object address group (Step 407), cache control unit 110 first updates LRU302 in the control information 133 that was received and then replaces control information 133 that preceded updating in control array 132 with control information 133 that follows updating (Step 408). If the address array number shown by LRU302 before updating is the number of the address array that stores the address at which the cache hit occurred, cache control unit 110 sets another address array number to LRU302 and updates LRU302.

Cache control unit 110 next determines whether block data that correspond to the address group that contains the address at which the cache hit occurred (hereinbelow referred to as the “cache hit address group”) is being read from memory 3 or not based on the value indicated by F204 in status information 201 from the address array that stores the cache hit address group (Step 409).

If F204 indicates “1,” i.e., if block data that correspond to the cache hit address group are being read from memory 3 (Step 410), cache control unit 110 waits until reading is completed.

On the other hand, when F204 indicates “0,” i.e., when block data that correspond to the cache hit address group are not being read from memory 3 (Step 411), cache control unit 110 specifies the data entry that store block data that correspond to the cache hit address group based on the way-number information from the address array that stores the cache hit address group.

Cache control unit 110 next specifies, within the block data that correspond to the cache hit address group in the data entry that was specified, the words that were accessed based on the data of 6 (k) lower-order bits 129 in address register 101 and writes write data to the words (Step 412).

Cache control unit 110 next sets to “1” the value indicated by D203 in status information 201 that is contained in the address entry that stores the cache hit address group (Step 413).

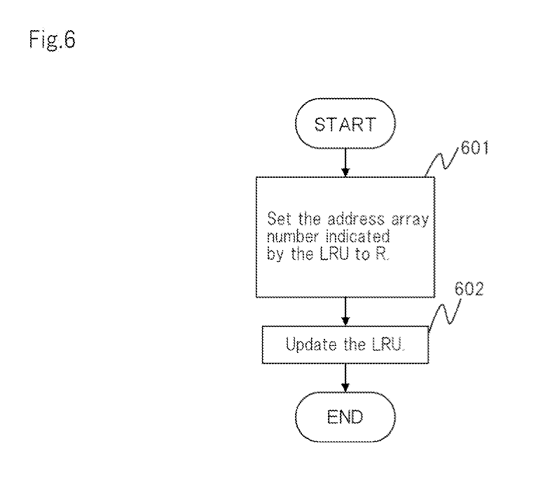

When the address contained in the replacement-object address group is a cache hit (Step 414), i.e., when the replacement-object address group is the cache hit address group, cache control unit 110 changes the replacement-object address group and updates the LRU (Step 415). Step 415 will later be described in greater detail with reference to FIG. 6.

Cache control unit 110 specifies the data entry that stores block data that correspond to the cache hit address group based on the way-number information from the address array that stores the cache hit address group.

Cache control unit 110 next specifies the words that were accessed based on the data of 6 (k) lower-order bits 129 in address register 101 from block data that correspond to the cache hit address group in the data entry that was specified and writes write data to the words (Step 416).

Cache control unit 110 then sets to “1” the value shown by D203 in status information 201 that is contained in the address entry that stores the cache hit address group (Step 417).

When cache control unit 110 determines a cache miss (Step 405), cache control unit 110 refers to W0304 and W1305 in control information 133 to determine whether to generate replacement of the block (i.e., block data and an address group corresponding to the block data) (Step 418).

When all of the data entries that are accessed according to 10 (n) intermediate-order bits 122 of the address from CPU 2 are in use, i.e., when both W0304 and W1305 indicate “1,” cache control unit 110 makes a determination to generate a replacement (Step 419).

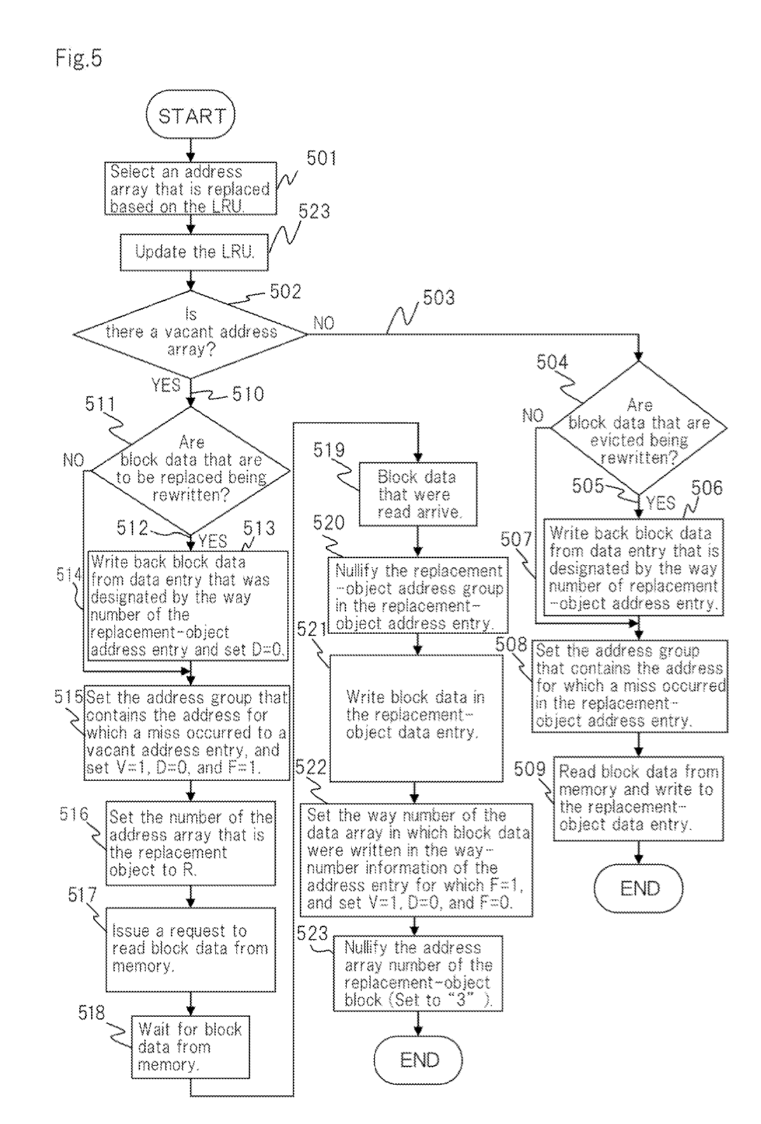

When a determination has been made to generate a replacement, cache control unit 110 specifies the address entry that stores the replacement-object address group in Step 422, and further, reads block data (relevant block data) that correspond to the address group (relevant address group) that contains the address of the cache miss from memory 3 and writes that block data (relevant block data) to data storage unit 12. Step 422 will later be described in detail using FIG. 5.

On the other hand, when there is more than one vacant data entry among data entries that have been accessed according to 10 (n) intermediate-order bits 122 of addresses from CPU 2, i.e., when at least one of W0304 and W1305 indicates “0,” cache control unit 110 makes a determination not to generate a replacement (Step 420).

When a replacement is not generated (Step 420), address entries that are invalid or still unused (hereinbelow referred to as “invalid-state address entries”) are present among address entries that have been accessed according to 10 (n) intermediate-order bits 122 of addresses from CPU 2, and moreover, invalid or still unused data entries (hereinbelow referred to as “invalid-state data entries”) are present among data entries that have been accessed in accordance with 10 (n) intermediate-order bits 122 of addresses from CPU 2.

Cache control unit 110 sets 48 (m) higher-order bits 124 of the address register in which the cache miss occurred in the 48 (m) higher-order bits in an invalid-state address entry and stores the relevant address group in the invalid-state address entry.

Cache control unit 110 further sets “1” in V202 in the status information in the invalid-state address entry, sets “0” in D203 in the status information in the invalid-state address entry, sets “1” in F204 in the status information in the invalid-state address entry, sets the way number of the data array that has invalid-state data entry in the way-number information 113 in the invalid-state address entry, and sets the invalid-state data entry to “in use” (more specifically, sets W0304 or W1305 to “1”).

Cache control unit 110 next reads from memory 3 the block data (relevant block data) that correspond to the address group (relevant address group) that includes the address from CPU 2.

Cache control unit 110 then writes the block data (relevant block data) that were read from memory 3 to the data entry that was changed to “in use” shown by the way-number information in the invalid-state address entry (Step 421).

Cache control unit 110 then writes the write data to, from among the words in the data entry that were changed to “in use,” words that were identified by the data of 6 (k) lower-order bits 129 of addresses from CPU 2 (Step 412) and then sets “1” to D203 in status information 201 in the invalid-state address entry (Step 413).

On the other hand, when command type information 128 is a load command (Step 423), cache control unit 110 executes Step 424.

In Step 424, cache control unit 110 determines whether the accessed data are present in data storage unit 12, i.e., determines whether a cache hit has occurred based on comparison results 125-127 and status information 112, 115, and 118.

Cache control unit 110 determines that a cache hit has occurred when comparison result 125 shows matching and V202 in status information 112 indicates “1,” when comparison result 126 shows matching and V202 in status information 115 indicates “1,” or when comparison result 127 shows matching and V202 in status information 118 indicates “1” (Step 425).

On the other hand, when all of the above conditions 1-3 are satisfied, cache control unit 110 determines that a cache miss has occurred (Step 426).

When a cache hit has been determined (Step 425), cache control unit 110 determines, by whether the value indicated by R303 in control information 133 matches the address array number of the cache hit, whether the address in which the cache hit occurred is an address in the replacement-object address group (Step 427).

When the address of a cache hit is not an address in the replacement-object address group (Step 428), cache control unit 110 first updates LRU302 in control information 133 that was received and writes control information 133 that preceded updating in control array 132 to control information 133 that follows updating (Step 429). If the address array number indicated by LRU302 before updating is the number of the address array that stores the address for which the cache hit occurred, cache control unit 110 sets another address array number in LRU 302 to update LRU302.

Cache control unit 110 next determines whether block data that correspond to the address group that contains the address for which the cache hit occurred (the cache hit address group) is now being read from memory 3 based on the value indicated by F204 in status information 201 from the address array that stores the cache hit address group (Step 430).

If F204 indicates “1,” i.e., if block data that correspond to the cache hit address group are being read from memory 3 (Step 431), cache control unit 110 waits until the reading is completed.

On the other hand, if F204 indicates “0,” i.e., if block data that correspond to the cache hit address group are not being read from memory 3 (Step 432), cache control unit 110 specifies the data entry that stores the block data that correspond to the cache hit address group based on way-number information from the address array that stores the cache hit address group.

Cache control unit 110 next specifies the words that were accessed based on the data of 6 (k) lower-order bits 129 in address register 101 from among the block data that correspond to the cache hit address group in the data entry that was identified and reads the data in these words (Step 433). Cache control unit 110 provides these data to CPU 2.

When a cache hit occurs in an address that is contained in a replacement-object address group (Step 434), i.e., when a replacement-object address group becomes a cache hit address group, cache control unit 110 changes the replacement-object address group and updates the LRU (Step 435). Step 435 will later be described in greater detail using FIG. 6.

Cache control unit 110 then specifies the data entry that stores block data that correspond to the cache hit address group based on the way-number information from the address array that stores the cache hit address group.

Cache control unit 110 next specifies the words that were accessed based on the data of 6 (k) lower-order bits in address register 101 from among the block data that correspond to the cache hit address group in the data entry that was specified and reads the data in these words (Step 436). Cache control unit 110 provides these data to CPU 2.

When a cache miss is determined (Step 426), cache control unit 110 refers to W0304 and W1305 in control information 133 to determine whether to generate a replacement of the block (the block data and the address group that corresponds to the block data) (Step 437).

When all of the data entries that were accessed according to 10 (n) intermediate-order bits 122 of the address from CPU 2 are in use, i.e., when both W0304 and W1305 indicate “1,” cache control unit 110 makes a determination to generate a replacement (Step 438).

When a determination has been made to generate a replacement, cache control unit 110 identifies the address entry that stores the replacement-object address group, and further, reads from memory 3 the block data (relevant block data) that correspond to the address group (relevant address group) that contains the address for which a cache miss occurred and writes these block data (relevant block data) to data storage unit 12 in Step 439. Step 439 will be later described in detail using FIG. 5.

On the other hand, when there is one or more vacant data entries among the data entries that were accessed in accordance with 10 (n) intermediate-order bits 122 of the address from CPU 2, i.e., when at least one of W0304 and W1305 indicates “0,” cache control unit 110 makes a determination not to generate a replacement (Step 440).

When a replacement does not occur (Step 440), invalid or still unused address entries (invalid-state address entries) are present in address entries that were accessed in accordance with 10 (n) intermediate-order bits 122 of the address from CPU 2, and moreover, invalid or still unused data entries (invalid-state data entries) are present in the data entries that were accessed in accordance with 10 (n) intermediate-order bits 122 of the address from CPU 2.

Cache control unit 110 sets 48 (m) higher-order bits 124 of the address register for which the cache miss occurred in the 48 (m) higher-order bits in the invalid-state address entry and stores the relevant address group in the invalid-state address entry.

Cache control unit 110 further sets V202 in the status information in the invalid-state address entry to “1,” sets D203 in the status information in the invalid-state address entry to “0,” sets F204 in the status information in invalid-state address entry to “1,” sets the way number of the data array that has the invalid-state data entry in the way-number information in the invalid-state address entry, and sets the invalid-state data entry to “in use” (more specifically, sets W0304 or W1305 to “1”).

Cache control unit 110 next reads block data (relevant block data) that correspond to the address group (relevant address group) that contains the address from CPU 2 from memory 3.

Cache control unit 110 then writes the block data (relevant block data) that were read from memory 3 to the data entry that was changed to “in use” which is indicated by the way-number information in the invalid-state address entries (Step 441).

Cache control unit 110 then reads data from the words that were specified by the data of 6 (k) lower-order bits of the address from CPU 2 among the words in the data entry that was changed to “in use” (Step 433). Cache control unit 110 then provides these data to CPU 2.

Steps 422 and 439 shown in FIG. 4 are next described with reference to FIG. 5.

Cache control unit 110 first selects the address array that is the object of replacement (to describe further, the replacement-object address entry that stores the replacement-object address group) in accordance with LRU302 in control information 133 (Step 501).

Cache control unit 110 next updates the value indicated by LRU302 in control information 133. More specifically, cache control unit 110 sets to LRU302 the number belonging to the address array among address arrays 102-104 for which the time of last access is the second oldest (Step 523).

Cache control unit 110 next refers to each V202 in status information 112, 115, and 118 to determine whether there is a vacant address array (more specifically, an invalid-state address entry among the address entries that were accessed in accordance with 10 (n) intermediate-order bits 122 of the address from CPU 2) (Step 502).

There isn't any vacant address array 102 (invalid-state address entry) when the plurality of V202 all indicate “1,” and there is a vacant address array (an invalid-state address entry) when even one of the plurality of V202 indicates “0.”

When there is no vacant address array (Step 503), cache control unit 110 determines, depending on whether D203 in status information 201 in the replacement-object address entry indicates “1” or indicates “0,” whether block data (relevant block data) that correspond to a replacement-object address group have been rewritten or not (Step 504).

If the block data (relevant block data) that correspond to the replacement-object address group have been rewritten (Step 505), cache control unit 110 identifies a data entry (hereinbelow referred to as “replacement-object data entry”) in the way that was indicated by the way-number information in the replacement-object address entry of the data entries that were accessed in accordance with 10 (n) intermediate-order bits 122 of the address from CPU 2 and writes back the block data in the replacement-object data entry to memory 3 (Step 506).

On the other hand, if block data (corresponding data blocks) that correspond to the replacement-object address group have not been rewritten (Step 507), cache control unit 110 does not carry out write-back.

Cache control unit 110 next writes data of 48 (m) higher-order bits 124 of address register 101 to 48 (m) higher-order bits in the replacement-object address entry. Cache control unit 110 further sets V202 and F204 in status information 201 in the replacement-object address entry to “1,” and sets D203 in status information 201 in the replacement-object address entry to “0” (Step 508).

Cache control unit 110 next issues a request to memory 3 to read block data for which a cache miss occurred and writes the block data (relevant block data) from memory 3 to the replacement-object data entry (Step 509).

If there is a vacant address array (Step 510), cache control unit 110 makes a determination, depending on whether D203 in status information 201 in the replacement-object address entry indicates “1” or “0,” whether block data (corresponding block data) that correspond to the replacement-object address group have been rewritten (Step 511).

If the block data (corresponding block data) that correspond to the replacement-object address group have been rewritten (Step 512), cache control unit 110 specifies, among the data entries that were accessed in accordance with 10 (n) intermediate-order bits 122 of the address from CPU 2, the data entry (replacement-object data entry) in the address array in the way that is indicated in the way-number information in the replacement-object address entry, writes back the block data in the replacement-object data entry to memory 3, and sets D203 in status information 201 in the replacement-object address entry to “0” (Step 513).

If, on the other hand, the block data that correspond to the replacement-object address group have not been rewritten (Step 514), cache control unit 110 does not carry out write-back.

Cache control unit 110 next writes the data of 48 (m) higher-order bits 124 of address register 101 to the 48 (m) higher-order bits in the vacant address entry (invalid-state address entry). As a result, the relevant address group is stored in an address entry that is still unused or made invalid.

Cache control unit 110 further sets V202 and F204 in status information 201 in the invalid-state address entry to “1” and sets D203 in status information 201 in the invalid-state address entry to “0” (Step 515).

Cache control unit 110 next updates the value of R303 in control information 133 to the number of the address array that has the replacement-object address entry and rewrites control information 133 that precedes updating in control array 132 to control information 133 that follows updating (Step 516).

Cache control unit 110 next issues a request to memory 3 to read the block data for which a cache miss occurred (Step 517).

Cache control unit 110 next waits for block data (relevant block data) from memory 3 (Step 518).

In the interval until the arrival of the block data, the address group that is the object of replacement and that is in an invalid state in the prior art is valid on the address array in the present exemplary embodiment.

Upon the arrival of the block data (relevant block data) from memory 3 (Step 519), cache control unit 110 first refers to R303 in control information 133 to identify the replacement-object address entry, sets V202 in status information 201 in the replacement-object address entry to “0,” and invalidates the replacement-object address group in the replacement-object address entry (Step 520).

Cache control unit 110 next refers to the way-number information in the replacement-object address entry to specify the replacement-object data entry and then writes the block data (relevant block data) that were read from memory 3 to the replacement-object data entry in place of the corresponding block data (Step 521).

Cache control unit 110 next writes the way number of the address array to which the block data were written in the way-number information in the replacement-object address entry in which F204 in status information 201 indicates “1.”

Cache control unit 110 then sets F204 in the replacement-object address entry to “0” (Step 522).

Finally, cache control unit 110 writes “3” to R303 in control information 133 and invalidates the settings that designate the replacement-object address entry (Step 523).

Steps 415 and 435 shown in FIG. 4 are next described with reference to FIG. 6.

Cache control unit 110 first sets the value indicated by R303 in control information 133 (the number of the address array that contains the replacement-object address entry) to LRU302 in control information 133 (Step 601).

Cache control unit 110 next sets to LRU302 the number belonging to, from among address arrays 102-104, the address array for which the time of last access is the second oldest (Step 602).

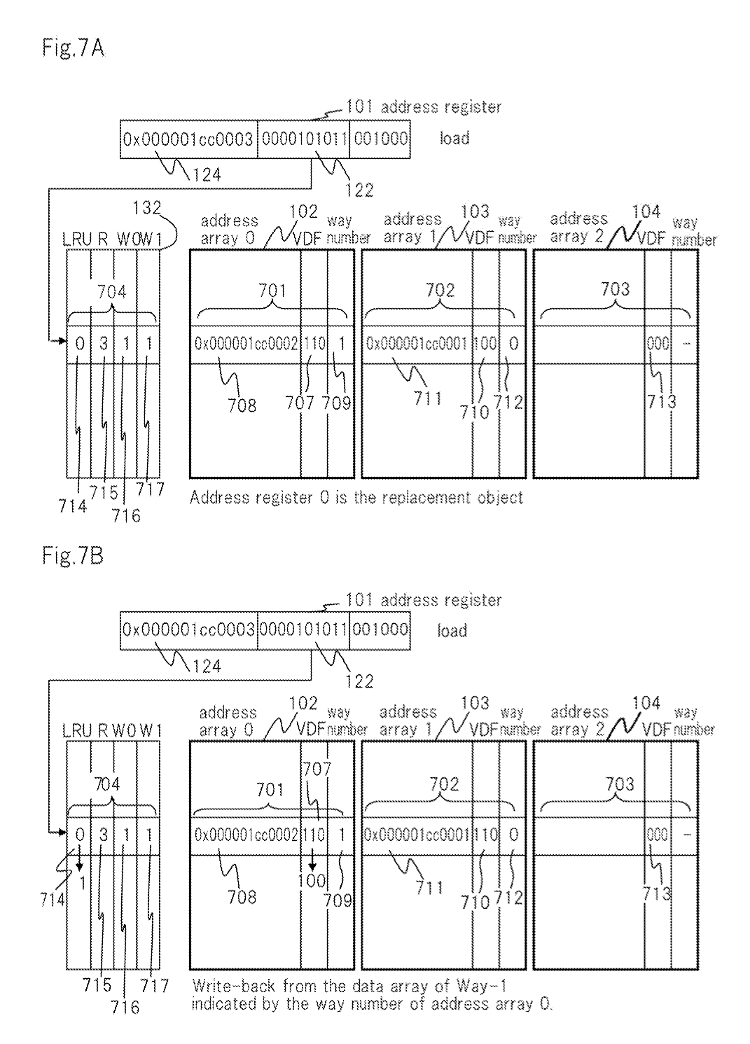

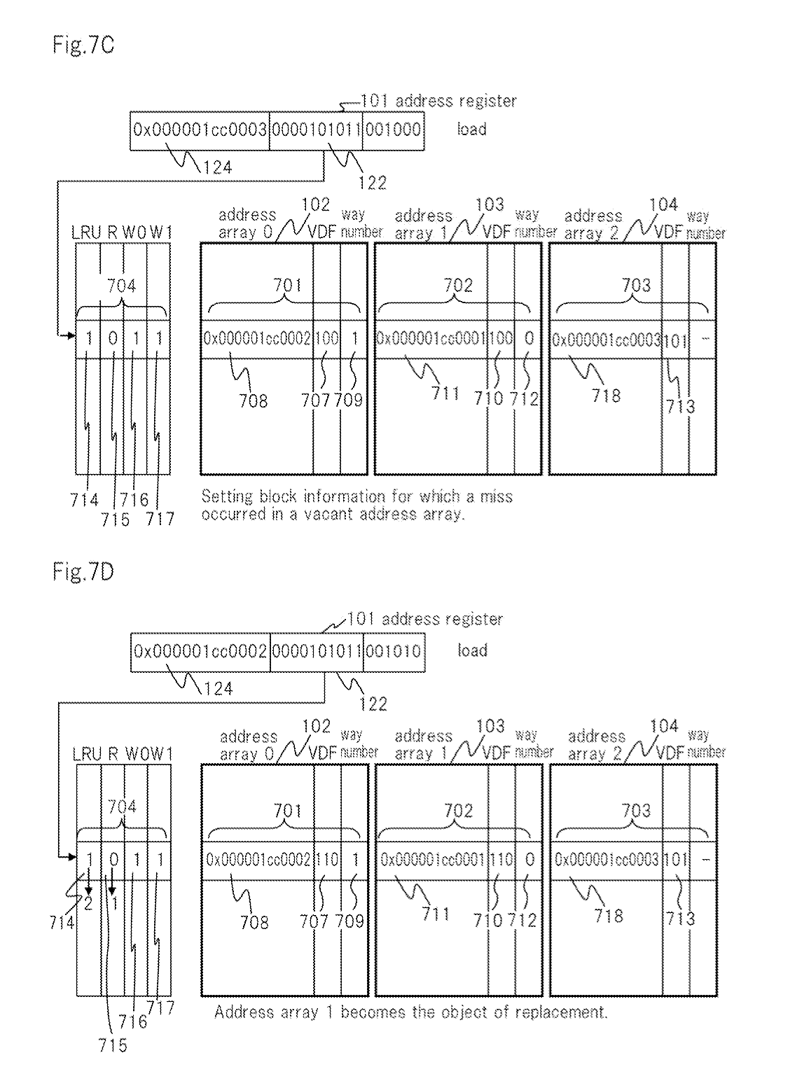

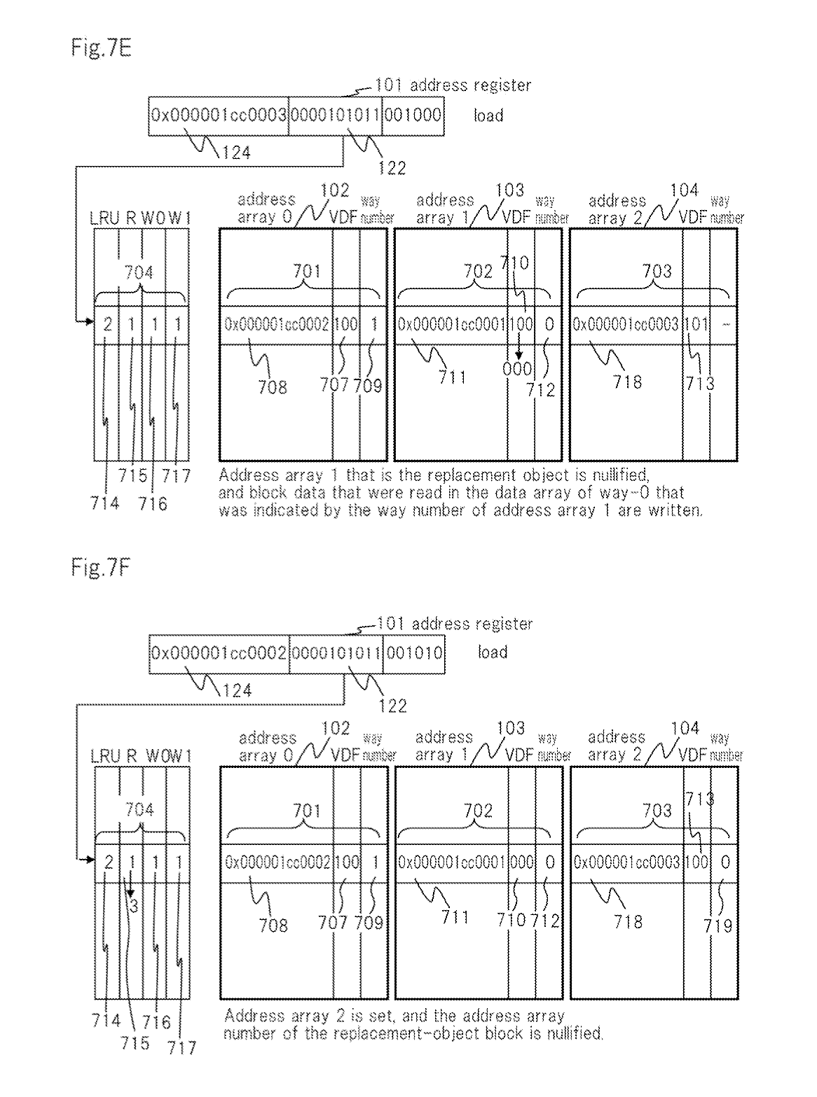

FIGS. 7A-7G are explanatory views for describing an example of the operations of cache memory system 1, and more specifically, an example of the operations of cache control unit 110. In FIGS. 7A-7G, components of the same construction as shown in FIG. 1 are given the same reference numbers.

In this case, cache memory system 1 having three address arrays and two ways of data arrays is used in the explanation.

The state immediately following the issue of a load command is first shown in FIG. 7A.

The binary number “0000101011” is stored in n intermediate-order bits 122 of address register 101.

Control information entries in control array 132, each address entry in address arrays 102-104, and each data entry of two ways (not shown in the figures) is accessed with “0000101011” as the index.

In the following explanation, it is assumed that from among the address entries in address array 102, address entry 701 is accessed; from among the address entries in address array 103, address entry 702 is accessed; from among the address entries in address array 104, address entry 703 is accessed; and from among the control information array in control array 132, control information array 704 is accessed.

First, in address entry 701, status information 707 indicates 110. As a result, address entry 701 is valid, and further, block data that correspond to the address group in address entry 701 are rewritten by CPU 2. The hexadecimal number “0x000001cc0002” is stored in m higher-order bits 708 and way-number information 709 indicates “1.”

Next, in address entry 702, status information 710 indicates 100. As a result, address entry 702 is valid, and block data that correspond to the address group in address entry 702 are not rewritten by CPU 2. The hexadecimal number “0x000001cc0001” is stored in m higher-order bits 711. Way-number information 712 indicates “0.”

Finally, in address entry 703, status information 713 indicates “000.” As a result, address entry 703 is invalid.

In control information entry 704, LRU714 indicates “0” (the number of address array 102). In other words, when a cache miss occurs using “0000101011” as an index, the object of replacement is address array 102 (more specifically, address entry 701). R715 indicates invalid. W0716 and W1717 are both “1.”

The hexadecimal number “0x000001cc0003” is stored in the m higher-order bits 124 of address register 101.

“0x000001cc0003” differs from both the data in m higher-order bits 708 of address entry 701 and the data in m higher-order bits 711 of address entry 702. As a result, the address in address register 101 is a cache miss.

Since both ways of the data array are in use, a replacement is generated. Since “0” is stored in LRU714, the object of replacement is the address group in address entry 701.

Replacement is next described using FIGS. 7B and 7C.

In FIG. 7B, cache control unit 110 first updates and sets LRU714 to “1.” Next, block data that correspond to the address group that is stored in address entry 70I that is replaced are rewritten by CPU 2, and cache control unit 110 therefore writes back to memory 3 block data that are stored in, from among the data entries that were accessed with “0000101011” as an index, the data entry in the data array of way 0 that was indicated by way-number information 709 of address entry 701. Cache control unit 110 then changes status information 707 in address entry 701 from 110 to 100.

In FIG. 7C, cache control unit 110 next sets data 124 of the m higher-order bits 124 of the address for which a cache miss occurred in address entry 703 that was vacant and sets status information 713 in address entry 703 to “101.” In other words, the relevant address group is stored in a still unused address entry.

Cache control unit 110 next sets number “0” that was conferred to address array 102 that has become the object of replacement in R715 in control array 132. Cache control unit 110 then requests memory 3 to read the block data (relevant block data) that correspond to the address group that includes the address for which a cache miss occurred.

FIG. 7D shows a case in which a cache hit occurs for an address in an address group that is stored in address entry 701 that is the object of replacement before the arrival in cache memory system 1 of block data that correspond to an address group that contains the address for which a cache miss occurred.

The hexadecimal number “0x000001cc0002” that is stored in m higher-order bits 124 of address register 101 is the same as the value that is stored in in higher-order bits 708 in address entry 701, and a cache hit therefore occurs.

In this case, cache control unit 110 changes the address array number that was indicated by 8715 in control information entry 704 from “0” to “1,” which is the value of LRU714. As a result, the address entry that is the object of replacement is changed from address entry 701 to address entry 702. Cache control unit 110 then updates the value indicated by LRU714 from “1” to “2.”

FIGS. 7E and 7F shows the processes at the point in time at which block data that correspond to the address group that contains the address at which a cache miss occurred are returned from memory 3.

In FIG. 7E, cache control unit 110 first invalidates the address group (the replacement-object address group following alteration) in address entry 702 in the address array that is the object of replacement that was indicated by R715 in control information entry 704.

Cache control unit 110 then changes the value indicated by status information 710 in address entry 702 from “100” to “000.” Cache control unit 110 then writes block data (relevant block data) that were read from CPU 3 to, from among data entries that were accessed with “0000101011” as an index, the data entry in the data array of way “0” that was indicated by way-number information 712 in address entry 702 in place of related block data that correspond to the replacement-object address group following alteration.

In FIG. 7F, cache control unit 110 changes the value indicated by status information 713 in address entry 703 from “101” to “100.” Cache control unit 110 then sets the way number “0” of the data array in which the block data were written to way-number information 719 in address entry 703. Cache control unit 110 then sets the value indicated by R715 in control information entry 704 to “3” and invalidates the object of replacement.

The effect of the present exemplary embodiment is next described.

According to the present exemplary embodiment, upon receiving the address in a replacement-object address group from CPU 2 during a reading interval, control unit 13 determines that a cache hit has occurred. As a result, the cache hit ratio can be improved.

In cache memory system 1 of the present exemplary embodiment, an action and effect similar to that described above is produced even when address register 101 is omitted.

In addition, increasing the number of address entries in which a replacement-object address group is stored enables the storage of the replacement-object address group even in the event of a multiplicity of cache misses at substantially the same time, and thus enables the prevention of a decrease in the cache hit ratio.

In addition, according to the present exemplary embodiment, the occurrence of a cache hit can be determined in the set-associative scheme, and a decrease in speed of a search that is carried out when determining a cache hit can therefore be prevented.

In the present exemplary embodiment, moreover, when an address in the replacement-object address group is received from CPU 2 during a read interval, control unit 13 further changes the replacement-object address group to another address group among the plurality of address groups, and both stores the relevant block data that correspond to the address group that contains the reception address in data storage unit 12 in place of the block data that correspond to the replacement-object address group that follows change and invalidates the replacement-object address group that follows the change in address storage unit 11.

In this case, errors in the selection of the replacement-object address group can be prevented and the cache hit ratio can be improved.

In the present exemplary embodiment, moreover, each address entry also stores storage destination information that indicates the data entry that stores block data that correspond to the address groups that are stored in that address entry. Control unit 13 refers to the storage destination information to identify the data entry in which corresponding block data are stored. In this case, the storage destination information can be used to identify the data entry in which corresponding block data are stored.

Although the invention of the present application has been described with reference to an exemplary embodiment, the invention of the present application is not limited to the above-described exemplary embodiment. The construction and details of the invention of the present application are open to various modifications within the scope of the invention of the present application that will be clear to a person of ordinary skill in the art.

This application claims the benefits of priority based on Japanese Patent Application No. 2009-045989 for which application was submitted on Feb. 27, 2009 and incorporates by citation all of the disclosures of that application.

### Explanation of Reference Numbers

1 cache memory system

11 address storage unit

12 data storage unit

13 control unit

101 address register

102-104 address arrays

105-106 data arrays

107-109 comparators

110 cache control unit

132 control array

2 CPU

3 memory

1. A cache memory system that is connected to an arithmetic unit and a memory apparatus, comprising:
an address storage unit that stores, from among a multiplicity of address groups in which addresses of said memory apparatus are organized by a predetermined number, a plurality of address groups that are fewer in number than said multiplicity of address groups;
a data storage unit that stores a plurality of block data that correspond to each of said plurality of address groups; and
a control unit that when a reception address from said arithmetic unit is not in said address storage unit, specifies a replacement-object address group from among said plurality of address groups, and moreover, stores, from among said multiplicity of address groups, a relevant address group that includes said reception address in said address storage unit and then reads from said memory apparatus relevant block data that correspond to said relevant address group and stores said relevant block data in said data storage unit;
wherein said control unit determines that a cache hit has occurred in the event of receiving from said arithmetic unit an address in said replacement-object address group, in a reading interval from specifying said replacement-object address group until reading said relevant block data from said memory apparatus, and in the event of not receiving from said arithmetic unit an address in said replacement-object address group in said reading interval, both stores said relevant block data in said data storage unit in place of corresponding block data that correspond to said replacement-object address group and invalidates said replacement-object address group.

2. The cache memory system according to claim 1, wherein, when said control unit receives an address in said replacement-object address group from said arithmetic unit in said reading interval, said control unit further changes said replacement-object address group to another address group among said plurality of address groups, and both stores said relevant block data in said data storage unit in place of block data that correspond to the replacement-object address group that follows the change and invalidates said replacement-object address group that follows the change.

3. The cache memory system according to claim 1, wherein:
each of said multiplicity of address groups is composed of addresses in which, when each address of said memory apparatus is divided into higher-order bits, intermediate-order bits, and lower-order bits, the values of said higher-order bits and values of intermediate-order bits are shared;
said data storage unit has N data storage areas (where N is an integer equal to or greater than 2) that correspond to relevant indexes for each index that indicates each of values that can be represented by said intermediate-order bits;
each of said plurality of block data is individually stored in, from among said data storage areas, a data storage area that corresponds to an index that indicates the values of intermediate-order bits of an address that corresponds to relevant block data;
said address storage unit has a greater number than said N of address storage areas that correspond to relevant indexes for each of said indexes;
each of said plurality of address groups is individually stored in, from among said address storage areas, an address storage area that corresponds to an index that indicates the values of intermediate-order bits of a relevant address; and
when said reception address is not in said address storage unit, said control unit specifies, from among said plurality of address groups, said replacement-object address group from among address groups that include the same intermediate-order bits as said reception address, and moreover, stores said relevant address group in an address storage area that is still unused or that has been invalidated among said address storage areas that correspond to indexes that indicate values of the intermediate-order bits of said reception address; and when an address in said replacement-object address group is not received from said arithmetic unit in said reading interval, both stores said relevant block data in the data storage area that stores said corresponding block data in place of said corresponding block data and invalidates said replacement-object address group.

4. The cache memory system according to claim 3, wherein:
said address storage areas further store storage destination information that indicates data storage areas that store block data that correspond to address groups that are stored in said address storage areas; and
said control unit refers to said storage destination information to specify data storage areas that store said corresponding block data.

5. The cache memory system according to claim 3, wherein, when said control unit receives an address in said replacement-object address group from said arithmetic unit in said reading interval, said control unit further changes said replacement-object address group to, among said plurality of address groups, another address group among address groups that include intermediate-order bits that are the same as said reception address; and both stores said relevant block data in a data storage area that stores related block data that correspond to the replacement-object address group that follows the change in place of said related block data and invalidates said replacement-object address group that follows the change.

6. A cache memory control method realized by a cache memory system that is connected to an arithmetic unit and a memory apparatus, said cache memory control method comprising:
storing in an address storage unit, from among a multiplicity of address groups in which addresses of said memory apparatus are organized by a predetermined number, a plurality of address groups that is fewer in number than said multiplicity of address groups;
storing in a data storage unit a plurality of block data that correspond to each of said plurality of address groups; and
when a reception address from said arithmetic unit is not in said address storage unit, executing an operation including: specifying a replacement-object address group from among said plurality of address groups; and moreover, storing in said address storage unit, from among said multiplicity of address groups, a relevant address group that includes said reception address; then reading from said memory apparatus relevant block data that correspond to said relevant address group; and storing said relevant block data in said data storage unit;
wherein said executing the operation includes: determining that a cache hit has occurred in the event of receiving from said arithmetic unit an address in said replacement-object address group in a reading interval from specifying said replacement-object address group until reading said relevant block data from said memory apparatus, and in the event of not receiving from said arithmetic unit an address in said replacement-object address group in said reading interval, both storing said relevant block data in said data storage unit in place of corresponding block data that correspond to said replacement-object address group and invalidating said replacement-object address group.

7. The cache memory control method according to claim 6, wherein said executing the operation further includes: when an address in said replacement-object address group is received from said arithmetic unit in said reading interval, changing said replacement-object address group to another address group among said plurality of address groups and both storing said relevant block data in said data storage unit in place of block data that correspond to the replacement-object address group that follows the change and invalidating said replacement-object address group that follows the change.

8. The cache memory control method according to claim 6, wherein:
each of said address groups is composed of addresses in which, when each address of said memory apparatus is divided into higher-order bits, intermediate-order bits, and lower-order bits, the values of said higher-order bits and values of intermediate-order bits are shared;
said data storage unit has N data storage areas (where N is an integer equal to or greater than 2) that correspond to relevant indexes for each index that indicates each of a plurality of values that can be represented by said intermediate-order bits;
each of said plurality of block data is individually stored in, from among a plurality of said data storage areas, a data storage area that corresponds to an index that indicates the values of intermediate-order bits of an address group that corresponds to relevant block data;
said address storage unit has a greater number than said N of address storage areas that correspond to relevant indexes for each of said indexes;
each of said plurality of address groups is individually stored in, from among a plurality of said address storage areas, an address storage area that corresponds to an index that indicates the values of intermediate-order bits of a relevant address group; and
said executing the operation includes: when said reception address is not in said address storage unit, specifying among said plurality of address groups said replacement-object address group from among address groups that include the same intermediate-order bits as said reception address, and moreover, storing said relevant address group in an address storage area that is still unused or that has been invalidated among said address storage areas that correspond to indexes that indicate values of the intermediate-order bits of said reception address;
and when an address in said replacement-object address group is not received from said arithmetic unit in said reading interval, both storing said relevant block data in the data storage area that stores said corresponding block data in place of said corresponding block data and invalidating said replacement-object address group.

9. The cache memory control method according to claim 8, wherein
said address storage areas further store storage destination information that indicates data storage areas that store block data that correspond to address groups that are stored in said address storage areas; and
said executing the operation includes referring to said storage destination information to specify data storage areas that store said corresponding block data.

10. The cache memory control method according to claim 8, wherein said executing the operation further includes: when an address in said replacement-object address group is received from said arithmetic unit in said reading interval, changing said replacement-object address group to, among said plurality of address groups, another address group among address groups that include intermediate-order bits that are the same as said reception address, and both storing said relevant block data in a data storage area that stores related block data that correspond to the replacement-object address group that follows the change in place of said related block data and invalidating said replacement-object address group that follows the change.
